(19) United States
(12) Patent Application Publication
(10) Pub. No.: US 2007/0256645 A1
(43) Pub. Date: Nov. 8, 2007

(54) Newborn bovine ear protector

(76) Inventor: Lynann Faye Rustad, Fargo, ND (US)

Correspondence Address: Lynann Faye Rustad, 2538 Arrowhead Road South, Fargo, ND, 58103, US

(21) Appl. No.: 11/787,243

(22) Filed: Apr. 16, 2007

Related U.S. Application Data
(60) Provisional application No. 60/798,361, filed on May 5, 2006.

(51) Int. Cl. A01K 13/00

(52) U.S. Cl. 119/851

(57) ABSTRACT

The newborn bovine ear protector is protective apparel made of weather resistant, moisture resistant, man-made material, having openings for eyes and mouth, which fits securely onto and around the snout of the animal from nose toward neck over top of head, and ears. Its purpose is to protect the newborn bovine from frost-bite or freezing of its ears, a problem that can result in loss of market value. It is held in place: (A) by way of re-sealable closure strips, which fasten across the back of the neck of the animal enclosing a section of the material and (B) by the conformity of the apparel to the head and snout of the animal. It can be humanly removed by physically disengaging the closure and guiding the apparel back across the snout toward the nose of the animal.

This application claims benefits of provisional application number 60/798,361 filed on May 5, 2006.

### STATEMENT OF FEDERALLY SPONSORED RESEARCH/DEVELOPMENT

Not Applicable

### SEQUENCE LISTING

Not Applicable

### BACKGROUND OF THE INVENTION

The Newborn Bovine Ear Protector is being offered under Class 119, Animal Husbandry, Sub-Class 850, Body Worn Protective Shield or Apparel. This invention addresses the necessity for protection against freezing of the ears of newborn calves. Risk of freezing to the ears is greatest during the first 24 to 72 hours after birth. Freeze damage to the ears can result in significant loss of market value—up to 20% according to statements taken directly from cattle ranchers questioned by this patent applicant.

The current state of technology is relegated to home made, improvised methods, none of which have been proven to be a lasting or satisfactory solution. A solution to this problem must include a design which cannot be removed by the animal or other animals or by the natural routine of suckling, sleeping, and normal movement of the animal. The design should promote free movement of the ears within the protective covering in order for the animal to maintain equilibrium; the ability to properly feed or suckle in order to maintain nutritional health; and it should also promote uninhibited vision and breathing for the animal.

It is the object of the invention to address these important aspects of design, dependability, and protection from freezing of the ears for the promotion of healthy, high market valued animals, specifically, registered and non-registered dairy, beef, and show cattle.

### HISTORY OF PRIOR ART

At this time there appears to be no prior patented art for this particular invention. Searches have been done on the USPTO database. Information acquired through the direct inquiries by the patent applicant to the cattle ranching industry provide the basis of need for this invention.

### BRIEF SUMMARY OF THE INVENTION

This protective ear device is designed to securely fit onto the head of the newborn calf. The apparel is designed in such a way as the ears have normal movement and position so as not to inhibit the sense of balance, and having openings for both eyes and for mouth to allow for complete ability to see, to feed, and to breathe normally without interference by the apparel.

The man-made material is double layered, weather resistant, water resistant, pliable, washable, and re-usable. Specifically, the material used in the protective apparel is resistant to any moisture, including water, waste, mucous, and saliva or other liquid that has the potential to freeze.

The fit of the apparel prevents removal through the natural instincts, e.g., of the mother to lick the head of the calf or suck at the ears of the calf; or by the natural instinct of the calf to rub against an object in order to remove the protective apparel. It can be humanly removed by physically disengaging the closure and guiding the apparel back across the snout toward the nose of the animal.

The object of the invention is to provide a safe and effective means to prevent freezing of ears during the first 72 hours of life in a newborn bovine thus ensuring the health of the animal and the market value of the animal.

### BRIEF DESCRIPTION OF THE SEVERAL VIEWS OF THE DRAWING

In the following figures dotted lines represent normal seam stitching. Zig zag lines represent attachment position of nylon overlay and attachment position of guide loops.

FIG. 1 Front view of newborn bovine ear protector in place on head of calf showing ear position; eye openings; mouth opening; center seam; and placement of nylon overlay on outside ear area.

FIG. 2 Side view of ear protector showing openings for eye, mouth, and neck areas; ear position; closure strip placement; guide loop placement; nylon overlay on ear area; and side seam.

FIG. 3 Back view of ear protector showing closure strips in open position; placement of guide loops; and nylon overlay on ear areas.

FIG. 4 Back view of ear protector showing ear position with nylon overlay; guide loops; closure strips in closed position; and enclosed area of material at neck back.

FIG. 5 Exploded view showing specific parts of protective apparel: back of head and ear part; main body of protective apparel; two closure strips; two guide loop pieces; two rectangle pieces of nylon overlay with broken line representing the cutting area of outside ear edges.

### DETAILED DESCRIPTION OF THE PREFERRED EMBODIMENT

The preferred embodiment is body worn protective apparel as defined in USPTO Classification 119 Animal Husbandry, Subclass 850 Body Worn Protective Shield or Apparel.

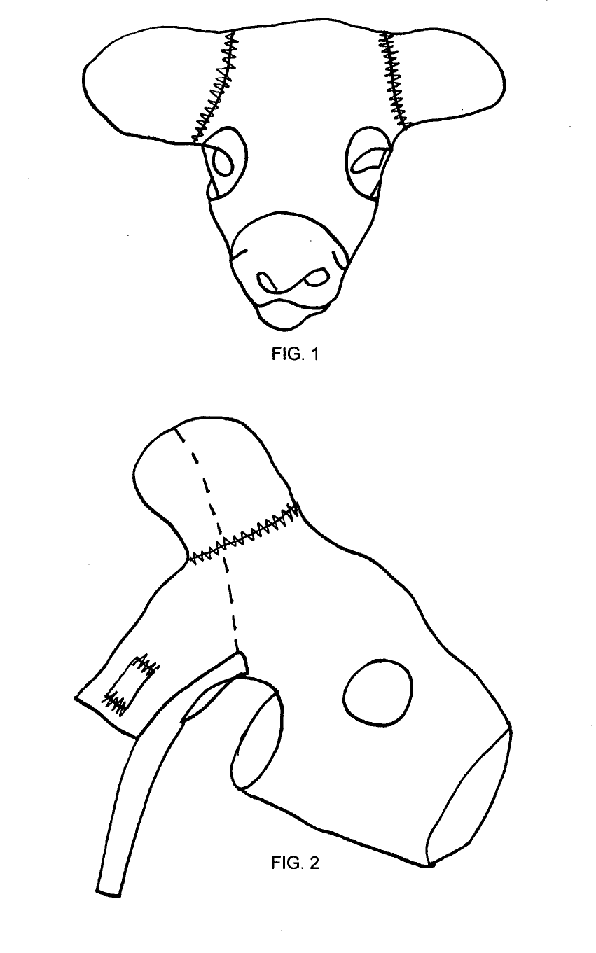

FIG. 1 describes the protective apparel as it would appear in place on the head of the calf. The apparel fits closely along the snout and head of the animal in such a way as to enclose the ears within double-layered weather resistant material. Openings for the eyes, nose and mouth can be observed in FIG. 1. The protective apparel is comprised of ten parts, all of which are shown in FIG. 5.

The two main parts of the apparel conform to actual measurements of newborn calves. The measurements were averaged to obtain a fit suitable for all newborns. The double layered fabric allows for some ease thereby making an average measurement feasible.

Measurements include:

### Length of ears

### Distance between ears

### Distance between eyes

### Distance from base of ear to top of eye

### Diameter of eye both horizontal and vertical

### Length of head from center of space between ears to 1″ above nostrils.

### Circumference of snout near nostrils

### Circumference of jaw area

### Distance from center top of skull to center base of skull

### Distance at back of skull from the outermost side of right ear to outermost side of left ear.

A pattern is made using these measurements. It is then transferred to weather resistant material and cut. A four-thread serger machine with cotton wrapped poly thread is used to sew the parts together.

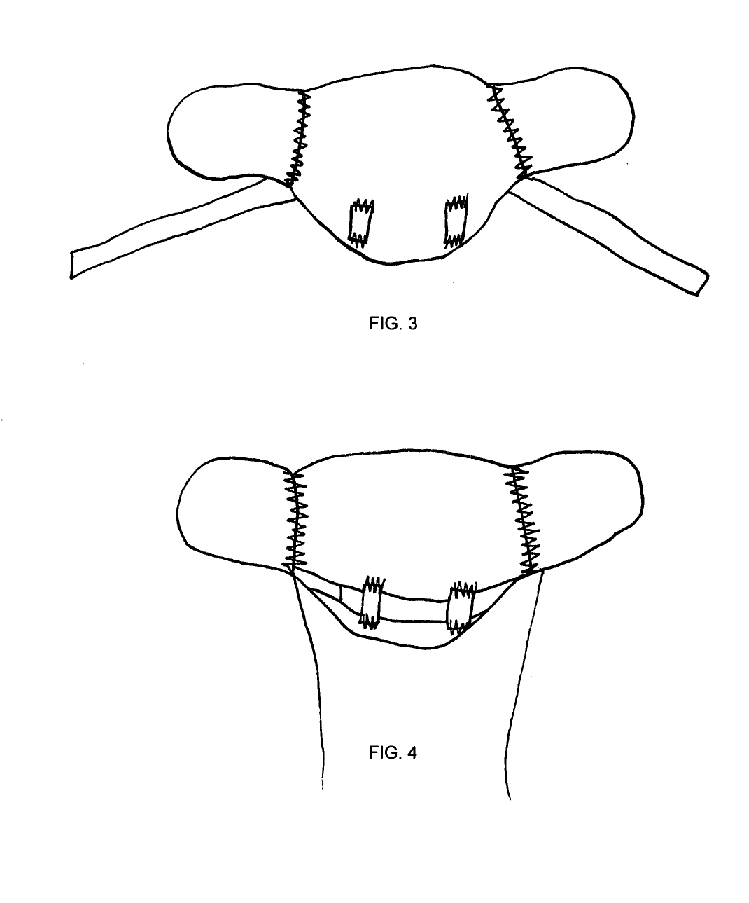

In the side view, FIG. 2, the neck opening and placement of the closure strip can be observed along with the eye and mouth openings. Two guide loops measuring one and one-half inches by one inch are sewn in place, one and one quarter inches on either side of center back and one quarter to one half inch from bottom edge, FIG. 3. The guide loops hold the closure strips in place.

The closure strips are cut from one inch wide hook and corresponding one inch wide loop. They are six inches in length. The closure strips are positioned at a slightly backward angle, FIG. 2, and fastened to the protective apparel at the base of the ear using a standard sewing machine. The reverse side of the loop closure strip lies against the back of the protective apparel, the loops facing away from the apparel. The hook side of the hook closure strip lies on top of the loop forming a secure closure. This procedure can be reversed so that the hook closure strip lies facing away from the apparel and the loop closure strip lies on top of the hook strip. The two strips must be positioned so that the hook side of one strip and the loop side of the second strip face each other.

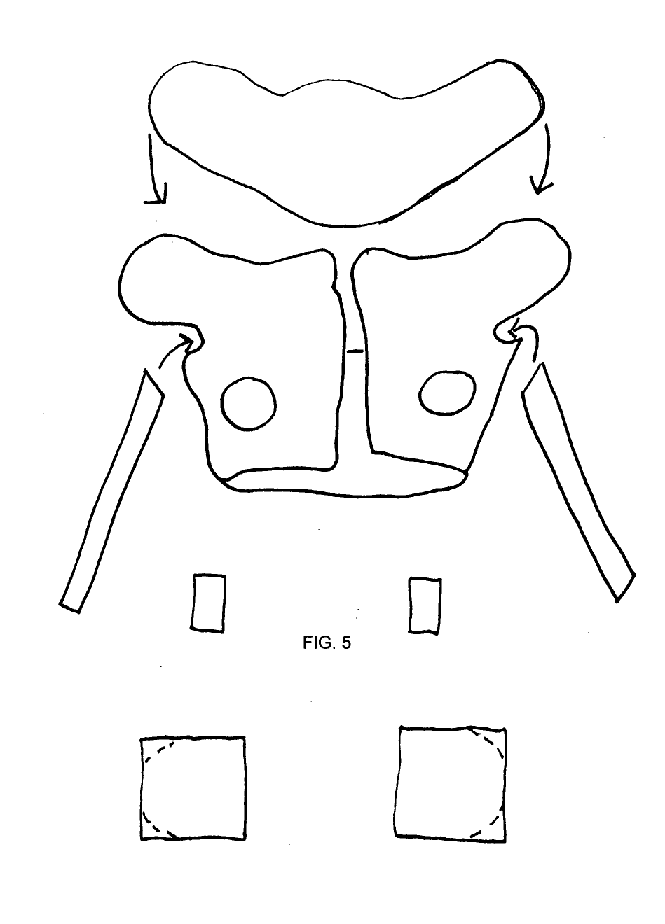

The placement of the closure strips is such that they can be guided along the back of the neck of the animal, through the guide loops as seen in FIG. 3 and then fastened to each other by means of hook and loop to form a secure closure, FIG. 4.

Four pieces of medium weight, moisture resistant nylon are cut, each measuring six inches by six inches.

The nylon is positioned on the outside of the four ear portions of the apparel such that the nylon extends to the outer edges of the seam allowances of the three outer edges of the ear portions of the apparel.

The four nylon pieces are attached to the ear portions of the apparel at the base of each of the four ear portions using a zigzag stitch to enclose the edge of the nylon overlay. The square nylon overlay is now attached to the apparel. The nylon overlay is trimmed around the outside of the ear portion even with the apparel fabric such that each nylon piece attains the shape of the ear portion to which it is sewn.

The center seam, FIG. 1, of the front of the apparel is sewn together with right sides facing and allowing a minimum of material to be cut by the knife of the serger machine.

The back of the apparel, with the fabric loops and nylon layers already sewn in place, is then pinned to the front of the apparel with right sides together starting from the center and working to the base of each ear section and ¼ to ½ inch beyond the attachment position of the hook and loop closure on the back of the apparel piece.

The apparel is placed under the presser foot of a serger sewing machine with the wrong side of the apparel facing up. The cutting blade of the serger is in the engaged position.

With the edges of the apparel pieces evenly aligned, the pinned area is seamed together making certain that the cutting blade of the machine is even with the raw edge of the apparel pieces.

Beginning at a point ¼ to ½ inch beyond the attachment position of the closure strip, the seam extends around the edge of the apparel pieces finishing at the opposite side at a point ¼ to ½ inch beyond the attachment position of the opposing closure strip. A minimum of fabric is allowed to be cut away by the blade of the serger machine in the area between the ear portions. It is important to keep apparel portions not included in the pinned area out of the way of the serger cutting blade and needle. The seam is ended leaving approximately one inch of thread extending.

The one inch threads are folded back onto the seam at the base of each ear. Using a zigzag stitch on a standard sewing machine, a one half inch length of the seam is reinforced and the one inch tail ends of the serged threads are stitched into the reinforced area. The ending threads are then trimmed close to the seam ending.

The apparel piece is complete at this point. Turn right side out making certain that the ear areas are fully extended. Remove any loose threads or lint from the exterior and interior of the apparel.

What is claimed is:

1. An ear protective apparel for newborn bovine made of weather and moisture resistant, pliable, washable, reusable material; which
completely covers the ears of said animal with openings for both eyes and an opening for mouth and nose; and
the ear portions designed such that natural positioning and free movement of ears is possible; and
fitted with a closure device attached at both sides of the apparel to secure placement of the apparel on the head of the animal; and
having the external ear portions of the apparel reinforced with an additional layer of weather resistant, moisture resistant, material.

2. An embodiment of an ear protective apparel as set forth in claim 1 wherein said apparel is comprised of synthetic material.

3. An embodiment of an ear protective apparel as set forth in claim 1 wherein the reinforced layer of the ear portions is comprised of a synthetic material.

4. An ear protective apparel as set forth in claim 1 wherein said closure device is comprised of hook and loop strips, one of either attached at each side of the apparel.

5. An ear protective apparel as set forth in claim 1 wherein two guide loops through which the closure strips pass are attached on each side of the back of the apparel.
